(19) United States
(12) Patent Application Publication
(10) Pub. No.: US 2010/0315001 A1
(43) Pub. Date: Dec. 16, 2010

(54) LIGHT EMITTING DIODE DEVICES CONFIGURED AS A REPLACEMENT TO LINEAR FLUORESCENT TUBE DEVICES

(76) Inventors: Thomas W. Domagala, Cottage Grove, MN (US); Myron C. Ostby, Big Lake, MN (US)

Correspondence Address: Hazen Patent Group, LLC, 1534 W. Islandia Dr., Gillbert, AZ, 85233, US

(21) Appl. No.: 12/797,030

(22) Filed: Jun. 9, 2010

Related U.S. Application Data
(60) Provisional application No. 61/268,345, filed on Jun. 11, 2009.

(51) Int. Cl. F21V 23/00

(52) U.S. Cl. 315/51

(57) ABSTRACT

The present invention is directed generally to lighting devices, and more particularly to white light LED-based lighting devices configured as a replacement to linear fluorescent tube devices. In a preferred embodiment of the present invention, the substrate may consist of multiple twelve-inch sections each with individual LEDs. In this configuration, 4 such twelve-inch sections may be aligned collinearly to form a 4 foot white light LED device similar to T5, T8, or T12 fluorescent light tubes.

### CROSS-REFERENCE TO RELATED APPLICATION

This application claims the benefit of U.S. Provisional Patent Application No. 61/268,345, filed Jun. 11, 2009, which is incorporated herein in its entirety by this reference thereto.

### FIELD OF THE INVENTION

The present invention is directed generally to lighting devices, and more particularly to white light LED-based lighting devices configured as a replacement to linear fluorescent tube devices.

### BACKGROUND

Energy conservation, in all its varied forms, has become a national priority of the United States as well as the rest of the world, from both the practical point of view of limited natural resources and recently as a security issue to reduce our dependence on foreign oil. A large proportion, some estimates are as high as one third, of the electricity used in residential homes in the United States each year goes to lighting. The percentage is much higher for many applications, such as in businesses and in street lights. Accordingly, there is an ongoing need to provide lighting, which is more energy efficient. It is well known that incandescent light bulbs are very energy inefficient light sources, where about ninety percent of the electricity consumed is released as heat rather than light. This heat adds to the cooling load of a system during cooling season. In heating season the cost per BTU of heat that the lights give off is typically more expensive than the cost per BTU of the main heat source. The heat that is given off by the lighting also can cause “over shooting” of the desired temperature which waists energy and makes the space feel uncomfortable. Fluorescent light bulbs are more efficient than incandescent light bulbs, such as by a factor of about four, but are still quite inefficient as compared to solid state light emitters, such as light emitting diodes (LED's).

In addition, as compared to the normal lifetimes of solid state light emitters, incandescent light bulbs have relatively short lifetimes, such as about 750 to 2000 hours. Fluorescent bulbs have longer lifetimes, such as about 8,000 to 20,000 hours, but provide less favorable color reproduction. In dramatic comparison, the lifetime of light emitting diodes, for example, can generally be measured in decades, such as about 100,000 hrs or more.

One established method of comparing the output of different light generating sources has been coined color reproduction. Color reproduction is typically given numerical values using the so-called Color Rendering Index (CRI). The color rendering index is a relative measurement of how the color rendition of an illumination system compares to that of a blackbody radiator. More particularly, it is a relative measure of the shift in surface color of an object when lit by a particular lamp. The CRI equals 100 if a set of test colors being illuminated by an illumination system are the same as the results as being irradiated by a blackbody radiator. Daylight has the highest CRI, with a value of 100; incandescent bulbs are relatively close, with a value of about 95; and fluorescent lighting is less accurate, with a CRI value of about 70 to 85. Certain types of specialized lighting have relatively low CRI's, such as mercury vapor or sodium based lighting both having CRI values as of about 40 or even lower. Sodium lights are used in many applications, such as to light highways and surface streets. Driver response time, however, significantly decreases with lower CRI values as for any given brightness, legibility decreases with lower CRI.

A practical issue faced by conventional lighting systems is the need to periodically replace the lighting devices, such as light bulbs. Such issues are particularly pronounced where access is difficult, such as in vaulted ceilings, bridges, high buildings, traffic tunnels, and/or where change-out costs are extremely high. The typical lifetime of conventional fixtures is about 20 years, corresponding to a light-producing device usage of at least about 44,000 hours, which is based on a typical usage of 6 hours per day for 20 years. In contrast light-producing device lifetimes are typically much shorter, thus creating the need for periodic change-outs. The potential number of residential homes that may be candidates for these periodic change-outs of the traditional incandescent lighting systems, including base fixtures and lamps themselves, is extremely large and represents an attractive commercial enterprise. For example, in the United States alone new residential home construction has average approximately 1.5 million dwellings per year over the last 30 years running. Even neglecting older homes built before 1978, this represents at least 45 million residential dwellings that are candidates for potential upgrades to more energy efficient LED-based lighting systems.

Accordingly, for these and other reasons, efforts have been ongoing to develop ways by which solid state light emitters can be used in place of incandescent lights, fluorescent lights, and other light-generating devices in a wide variety of applications. In addition, where solid state light emitters are already being used, efforts are ongoing to provide solid state light emitter-containing devices which are improved energy efficiency, color rendering index, contrast, and useful lifetime.

Light emitting diodes are well-known semiconductor devices that convert electrical current into light. A wide variety of light emitting diodes are used in increasingly diverse fields for an ever-expanding range of purposes. More specifically, light emitting diodes are semiconducting devices that emit light, such as ultraviolet, visible, or infrared light emitters, when an electrical potential difference is applied across a p-n junction structure. There are a number of well-known ways to make light emitting diodes and many associated structures, and the present invention can employ any such manufacturing technique.

The commonly recognized and commercially available light emitting diodes that are sold, for example, in electronics stores typically represents a “packaged” device made up of a number of parts. These packaged devices typically include a semiconductor-based light emitting diode and a means to encapsulate the light emitting diode. A light emitting diode produces light by exciting electrons across the band gap between a conduction band and a valence band of a semiconductor active or light-emitting layer. The electron transition generates light at a wavelength that depends on the band-gap energy difference. Thus, the color of the light emitted by a light emitting diode depends on the semiconductor materials of the active layers of the light emitting diode.

References related to the current invention are summarized herein.

M. Stenback, et.al. “Fluorescent Light Fixture”, U.S. Pat. No. 7,604,379 (Oct. 20, 2009) describe a fluorescent light fixture having a modular design capable of accommodating different types and numbers of light tubes.

R. Cross, et.al. “Retrofit Light Emitting Diode Tube”, U.S. Pat. No. 7,053,557 (May 30, 2006) describe a LED light tube for replacing fluorescent light tubes, which include an elongated cylindrical transparent envelope, a base at each end of the envelope, and at least one LED device in electrical communication with the base cap.

R. Cross, et.al. “Retrofit Light Emitting Diode Tube”, U.S. Pat. No. 6,936,968 (Aug. 30, 2005) describe a LED light tube for replacing fluorescent light tubes, which include an elongated cylindrical transparent envelope, a base at each end of the envelope, and at least one LED device in electrical communication with the base cap.

Although the development of solid state light emitters, such as light emitting diodes, has in many ways revolutionized the lighting industry, some of the characteristics of solid state light emitters have presented challenges, some of which have not yet been fully met. For example, the emission spectrum of any particular light emitting diode is typically concentrated around a single wavelength (as dictated by the light emitting diode's composition and structure), which is desirable for some applications, but not desirable for others, such as for providing lighting, given that such an emission spectrum typically provides a low CRI.

Given this, there is a need for a “white light” LED device capable of being configured such that key subassemblies may be replaced, thereby enabling the modification and/or repair of said device.

### SUMMARY OF THE INVENTION

Generally, the present invention is directed to lighting devices, and more particularly to white light LED-based lighting devices configured as a replacement to linear fluorescent tube devices.

### BRIEF DESCRIPTION OF THE DRAWINGS

The invention may be more completely understood in consideration of the following detailed description of various embodiments of the invention in connection with the accompanying drawings, in which:

FIG. 1 shows a schematic representation of one embodiment of the present invention depicting a white light LED device configured for direct replacement of existing fluorescent devices categorized by the American National Standards Institute (ANSI) as having part numbers T5, T8, and T12.

FIG. 2 shows a schematic representation of one embodiment of the present invention depicting the activating electronics to energize the solid state light emitting diodes (LEDs).

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE INVENTION

In general, the present invention is directed generally to lighting devices, and more particularly to white light LED-based lighting devices configured as a replacement to linear fluorescent tube devices.

One embodiment of the present invention describes a lighting device for generating diffuse white light comprising a group of solid state light emitters, said group including light emitting diodes energized by a direct current (DC) voltage, electronics to activate the solid state light emitters, wherein the electronics converts 120 volt 60 cycles per second alternating current to a steady state direct current (DC) voltage, an encapsulating housing enclosing the solid state light emitters and activating electronics having a shape and form factor substantially equivalent to any of the American National Standards Institute (ANSI) T5, T8, and T12 lighting device structures.

In another embodiment, light emitting diodes are used with a combination of wavelengths to produce white light. Because light that is perceived as white is necessarily a blend of light of two or more colors or wavelengths, no single light emitting diode can produce white light. “White light” emitting devices have been produced which have a light emitting diode structure comprising individual red, green, and blue light emitting diodes mounted on a common substrate. Other “white light” emitting devices have been produced which include a light emitting diode which generates blue light and a luminescent material, such as a phosphor, that emits both red and green in response to excitation by the blue LED output, whereby the blue, red and green when appropriately mixed, produce light that is perceived as white light. A wide variety of luminescent materials are well-known and available to persons of skill in the art. For example, a phosphor is a luminescent material that emits a responsive radiation, such as visible light, when excited by a source of exciting radiation. In many instances, the responsive radiation has a wavelength, which is different, typically longer, from the wavelength of the exciting radiation. Other examples of luminescent materials include day glow tapes and inks, which glow in the visible spectrum upon illumination with ultraviolet light. Luminescent materials can be categorized as being down-converting, such as a material which converts photons to a lower energy level or longer wavelength, or up-converting, such as a material that converts photons to a higher energy level or shorter wavelength. Inclusion of luminescent materials in LED devices has typically been accomplished by adding the luminescent materials to a clear plastic encapsulating material, such as an epoxy-based or silicone-based material.

As noted above, “white LED lights”, which are lights perceived as being white or near-white have been investigated as potential replacements for white light incandescent lamps. A representative example of a white LED lamp includes a package of a blue light emitting diode chip, made of gallium nitride (GaN), coated with a phosphor such as Yttrium Aluminum Garnet (YAG). In such an LED lamp, the blue light emitting diode chip produces a blue emission and the phosphor produces yellow fluorescence on adsorbing that emission. For instance, in some designs, white light emitting diodes are fabricated by forming a ceramic phosphor layer on the output surface of a blue light-emitting semiconductor light emitting diode. Part of the blue rays emitted from the light emitting diode pass through the phosphor, while part of the blue rays emitted from the light emitting diode chip are absorbed by the phosphor, which becomes excited and emits a yellow ray. The part of the blue light emitted by the light emitting diode, which is transmitted through the phosphor, is mixed with the yellow light emitted by the phosphor. The viewer perceives the mixture of blue and yellow light as white light.

In another type of LED lamp, a light emitting diode chip that emits an ultraviolet ray is combined with phosphor materials that produce red (R), green (G) and blue (B) light rays. In such an “RGB LED lamp”, the ultraviolet rays that have been radiated from the light emitting diode excites the phosphor, causing the phosphor to emit red, green and blue light rays which, when mixed, are perceived by the human eye as white light. Consequently, white light can also be obtained as a mixture of these light rays.

Designs have been realized in which existing LED's and other electronics are assembled into an integrated housing fixture. In such designs, an LED or plurality of LED's are mounted on a circuit board encapsulated within the housing fixture, and a heat sink is typically mounted to the exterior surface of the housing fixture to dissipate heat generated from within the device, the heat being generated by inefficient AC-to DC conversion from with the device. Typically, designs of this type are configured to be non-repairable when the LED's or other internal components fail, in these cases the devices are simply discarded. Also, designs of this type make it impossible to “upgrade” the devices to more efficient LED's as they become available.

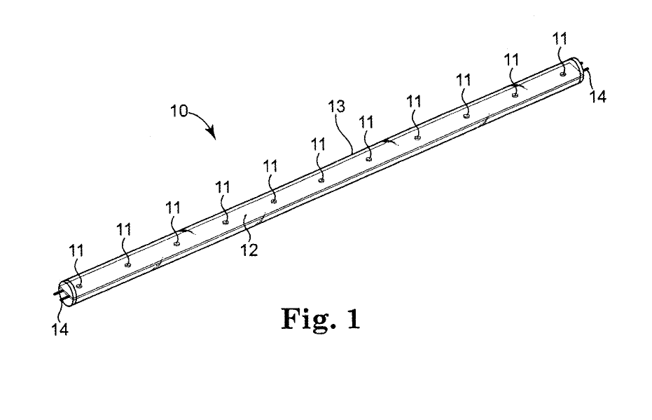

In yet another embodiment of a white light LED device 10 in accordance with the present invention is depicted schematically, FIG. 1. Fluorescent light bulb devices with the shape and form factor depicted in FIG. 1 have generally been categorized by the American National Standards Institute (ANSI) as having part numbers T5, T8, and/or T12, the difference being their diameter, increasing with higher numerical designation. Individual LEDs 11 may be mounted on substrate 12, which in one embodiment of the present may consist of standard circuit board material. The LED's are electrically connected to the grid using electrical connectors or electrical contacts 13. Optionally, the LED's are circumferentially surrounded or hemi-spherically covered along the length of the substrate 12 with an enclosure 14, such as a linear glass or plastic housing.

In a preferred embodiment of the present invention, the substrate 12 may consist of multiple twelve-inch sections each with individual LEDs 11. In this configuration, four such twelve-inch sections may be aligned collinearly to form a four foot white light LED device similar to T5, T8, or T12 fluorescent light tubes. Optionally, 2, 3, 4, 5 or more twelve inch sections are concatenated or formed as a single structure to form bulbs with a corresponding length of 2, 3, 4, 5 or more feet. Further, the base unit of the LED device is about 2, 4, 6, 8, 10, or 12 inches allowing LED bulbs of any length from about two inches to multiple feet.

In another embodiment, each concatenated section of the LED device includes LEDs operating at a given wavelength. For example, a first LED device operates at a first wavelength, a second LED device operates at a second wavelength, a third LED device operates at a third wavelength, and an n^{th} LED device operates at an n^{th} wavelength. Concatenated sections have LEDs in a longer bulb are thus configurable with multiple wavelengths yielding white light. Similarly, each section of the LED device 10 optionally contains 2, 3, 4 or more LED types of distinct wavelengths, which produce white light.

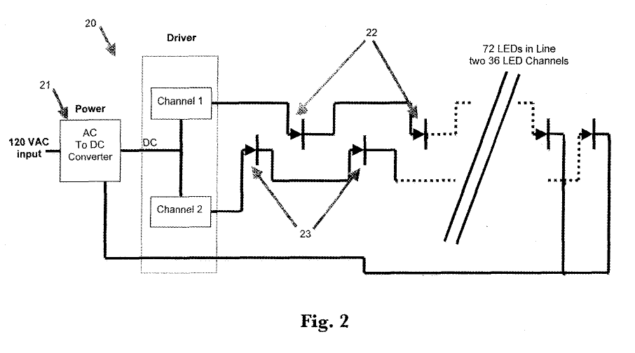

Referring now to FIG. 2, a schematic representation of one embodiment of the activating electronics 20 is illustrated. Activating electronics 20 optionally convert standard 120-volt alternating current signal to a direct current drive signal via AC-to-DC Converter device 21. The output of AC-to-DC Converter device 21 is optionally split into parallel channels 1 and 2. Parallel channels 1 and 2 optionally supply the energizing drive signal to light emitting diodes 22 and 23 also configured electrically in parallel. In this configuration, if one LED in channel 1, for example, were to fail for any reason, channel 2 LEDs would continue to light. Also, if the LED failure was limited to just one 12 inch strip, that strip could be replaced and the overall 4 foot device would be returned to full light output.

This modular strip design approach may make it possible to mix and match components for the following reasons:
1) In cases where the LEDs and/or activating electronics may fail, a replacement strip (comprising new LED's and activating electronics) may be mechanically and electrically collinearly mated with the remaining LED strips.
2) In cases where new more energy efficient LEDs become available, a replacement linear strip (encasing new LED's and activating electronics) may be mechanically mated with the remaining LED strips.
3) In cases where it is desirable to convert the activating electronics from DC (direct current) activating electronics to AC (alternating current) electronics or vice versa by way of replacing the LED strips.
4) In cases where it is desirable to convert the activating electronics from 115 Volts AC (U.S. standard) to 230 Volts AC (European standard) by way of replacing the encapsulating housing with appropriate LEDs.
5) In cases where it is desirable to convert the LEDs to change the color temperature of the white light LED device (for example, replacing a so-called “warm” LED as defined earlier in the specification above, with a so-called “cool” LED or vice versa).
6) In cases where it is desirable to replace the LEDs with different LED's with a different wattage rating.
7) In cases where it is desirable to replace the LEDs with different LED's with a different lifetime rating.
8) Or, in cases where it is desirable to change the number of LEDs in the device.

In yet another embodiment, one or more of the LED devices herein described are mounted in a casino game, such as a slot machine.

The present invention should not be considered limited to the particular examples described above, but rather should be understood to cover all aspects of the invention as fairly set out in the attached claims. Various modifications to the shape and form factors described above, equivalent processes to supplying the appropriate drive voltages to the LEDs, as well as numerous structures to which the present invention may be applicable will be readily apparent to those of skill in the art to which the present invention is directed upon review of the present specification. The following claims are intended to cover such modifications and devices.

1. A lighting device for generating diffuse white light, comprising:
a group of solid state light emitters, said group including light emitting diodes energized by a direct current voltage;
electronics to activate the solid state light emitters, wherein said electronics are configured to convert 120 volt, 60 cycles per second alternating current to the steady state direct current voltage;
an encapsulating housing enclosing said solid state light emitters and said activating electronics, said housing forming a shape and form factor substantially equivalent to the American National Standards Institute (ANSI) T5, T8, or T12 fluorescent light tubes.

2. The device of claim 1, further comprising a first linear strip, wherein at least two of said multiple solid state light emitters are co-linearly mounted on said first linear strip, wherein said solid state emitters each comprise a length of about twelve inches.

3. The device of claim 1, further comprising a second linear strip, wherein said activating electronics are mounted on said second linear strip.

4. The device of claim 1, wherein four of said first linear strips are aligned collinearly to form an about four foot long lighting device.

5. The device of claim 4, wherein individual activating electronics are in electrical communication with separate twelve-inch strips containing said solid state light emitters.

6. The device of claim 3, wherein said activating electronics comprise multiple parallel channels.

7. The device of claim 2, wherein said multiple solid state light emitters are aligned in parallel electrical channels.

8. The device of claim 1, wherein both said activating electronics and said solid state light emitter are mounted on said first linear strip.

9. The device of claim 1, wherein the electronics to activate the solid state light emitters are configured to convert 277 volt, 60 cycles per second alternating current to a steady state direct current voltage.

10. The device of claim 1, wherein the electronics to activate the solid state light emitters are configured to converts 480, volt 60 cycles per second alternating current to a steady state direct current voltage.

11. The device of claim 1, wherein multiple solid state light emitters are mounted on a planar linear strip approximately twelve inches in length.

12. The device of claim 1, wherein multiple solid state light emitters are mounted on a curved linear strip approximately twelve inches in length

13. The device of claim 12, wherein the linear strip is geometrically concave along the strip length.

14. The device of claim 12, wherein the linear strip is geometrically convex along the strip length.
